(19) United States
(12) Patent Application Publication
(10) Pub. No.: US 2013/0000975 A1
(43) Pub. Date: Jan. 3, 2013

(54) WIRE HARNESS PROTECTION STRUCTURE

(75) Inventors: Shinichi Igarashi, Yokkaichi-city (JP); Hiroaki Masuda, Yokkaichi-city (JP); Nobumasa Takihara, Yokkaichi-city (JP)

(73) Assignee: SUMITOMO WIRING SYSTEMS, LTD., Mie (JP)

(21) Appl. No.: 13/634,688

(22) PCT Filed: Oct. 18, 2010
(86) PCT No.: PCT/JP2010/068279

§ 371 Date: Sep. 13, 2012

(30) Foreign Application Priority Data
May 19, 2010 (JP) 2010-115138

(51) Int. Cl. H02G 3/04

(52) U.S. Cl. 174/72 A

(57) ABSTRACT

A wire harness protection structure includes a bundle of electric wires, and a protector formed into a tubular body that extends in a longitudinal direction of the bundle of electric wires and having a portion of the bundle of electric wires provided in an inner space of the tubular body. The protector is formed of a protection material including a base material and a binder material having a melting point lower than that of the base material. A joint portion of the protector is joined by heating and melting and then cooling and solidifying the binder material. The binder material in an inner peripheral surface is heated and melted and then cooled and solidified such that the inner peripheral surface, which faces the inner space, is harder than an outer peripheral surface of the protector.

### TECHNICAL FIELD

The present invention relates to a protection structure for a wire harness mounted in a vehicle. Specifically, the present invention relates to waterproofing on a protection structure.

### BACKGROUND ART

A water absorbing sheet is conventionally known, the water absorbing sheet providing a good water absorption capability while preventing water absorbing resin particles from leaking to an exterior (e.g., Patent Literature 1). Furthermore, a technology is also conventionally known to secure a waterproof character using water absorbing nonwoven fabric (e.g., Patent Literature 2).

### CITATION LIST

### Patent Literature

Patent Literature 1: Japanese Utility Model Laid-Open Publication No. H06-045482

Patent Literature 2: Japanese Patent Laid-Open Publication No. 2006-014536

### SUMMARY OF INVENTION

### Technical Problem

In an environment where dew condensation is occurring, however, simply using the water absorbing sheet in Patent Literature 1 and the water absorbing nonwoven fabric in Patent Literature 2 cannot sufficiently inhibit water from adhering to a wire harness mounted in a vehicle.

In view of the circumstance above, an object of the present invention is to provide a wire harness protection structure that provides good protection of a wire harness in the environment where dew condensation is occurring.

### Solution to Problem

In order to address the circumstance above, a wire harness protection structure according to a first aspect includes a bundle of electric wires and a protector formed into a tubular body extending in a longitudinal direction of the bundle of electric wires and provided with a portion of the bundle of electric wires in an inner space of the tubular body. The protector is formed of a protection material that includes a base material and a binder material having a melting point lower than that of the base material. A joint portion of the protector is joined by heating and melting and then cooling and solidifying the binder material. The binder material in an inner peripheral surface, which faces the inner space, is heated and melted and then cooled and solidified such that the inner peripheral surface is harder than an outer peripheral surface of the protector.

In the wire harness protection structure according to a second aspect, the protector in the protection structure of the first aspect is formed into a shape corresponding to a location where the protector is provided.

### Advantageous Effects of Invention

In the wire harness protection structure according to the first and second aspects, the binder material in the inner peripheral surface of the protector is heated and melted and then cooled and solidified such that the inner peripheral surface, which faces the inner space, is harder than the outer peripheral surface of the protector. Thus, water adhered to the outer peripheral surface of the protector is blocked by the inner peripheral surface of the protector. Therefore, the water is prevented from leaking into the inner space of the protector and from adhering to the bundle of electric wires.

In the wire harness protection structure according to the second aspect, the protector is formed into a shape corresponding to a location where the protector is provided. This enables easy wiring of the bundle of electric wires in the location. Therefore, a problem of unnecessary extension of the bundle of electric wires is prevented.

### BRIEF DESCRIPTION OF DRAWINGS

FIG. 1 is a perspective view illustrating an exemplary configuration of a wire harness protection structure according to an embodiment of the present invention.

FIG. 2 is a side view illustrating an exemplary configuration of a mold used for molding a protection structure.

FIG. 3 is a side view illustrating an exemplary method of forming the protection structure.

### DESCRIPTION OF EMBODIMENTS

Embodiments of the present invention are described below in detail with reference to the drawings.

<1. Configuration of Wire Harness Protection Structure>

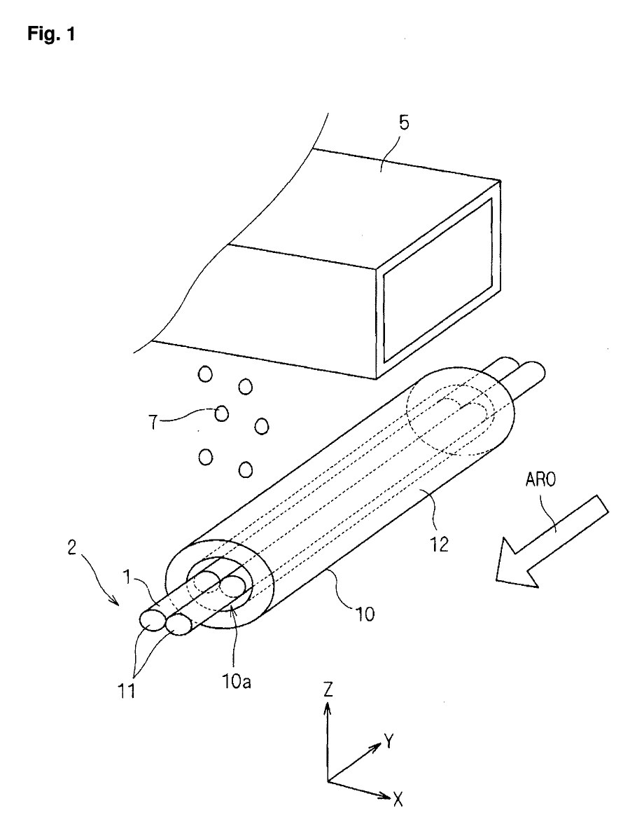

FIG. 1 is a perspective view illustrating an exemplary configuration of a protection structure 2 for a wire harness 1 according to an embodiment of the present invention. As shown in FIG. 1, the protection structure 2 mainly includes the wire harness 1 and a protector 10. In order to clarify a directional relationship of these components, FIG. 1 and the drawings thereafter include, as needed, an XYZ rectangular coordinate system in which a Z-axis direction is a perpendicular direction and an XY plane is a horizontal plane.

As shown in FIG. 1, the wire harness 1 is a bundle of electric wires composed of a bundled plurality of electric wires 11. The wire harness I is used for power supply to and transmission and reception of signals to/from electric components (not shown in the drawings), for example.

In an environment where dew condensation is occurring, such as in a vicinity of a duct 5 for an air conditioner (see FIG. 1), the protector 10 prevents water 7 from leaking into the wire harness 1. With reference to FIG. 1, the protector 10 is a tubular body formed of nonwoven fabric 12 (protection material) and extends in a longitudinal direction of the wire harness 1 (direction of an arrow AR0). A portion of the wire harness 1 is provided in an inner space 10a of the tubular protector 10, as shown in FIG. 1.

The protector 10 here is formed of the nonwoven fabric 12, for example. The nonwoven fabric 12 is mainly composed of PET (polyethylene terephthalate: base material) and a binder material formed of a copolymer of PET and PEI (polyethylene isophthalate). More specifically, the nonwoven fabric 12 is mainly composed of elementary fibers formed of the base material and shaped into a line and binder fibers formed of the sheath-shaped binder material provided around the elementary fibers.

A melting point of the binder material (second temperature) is 110 to 150° C. and is defined so as to be lower than that of the base material (a melting point of PET: approximately 250° C. (first temperature)).

<2. Method of Producing Protection Structure>

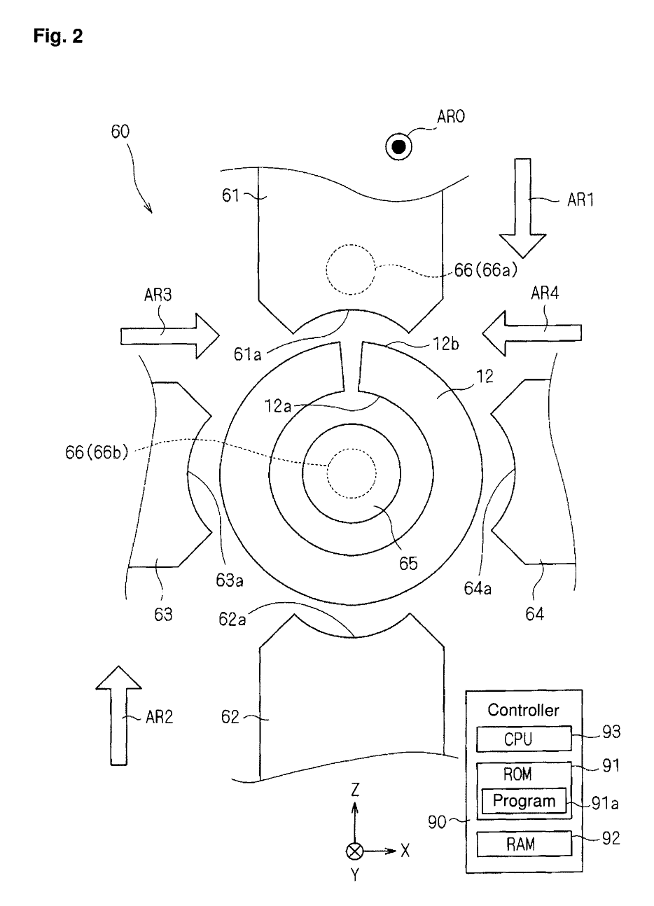

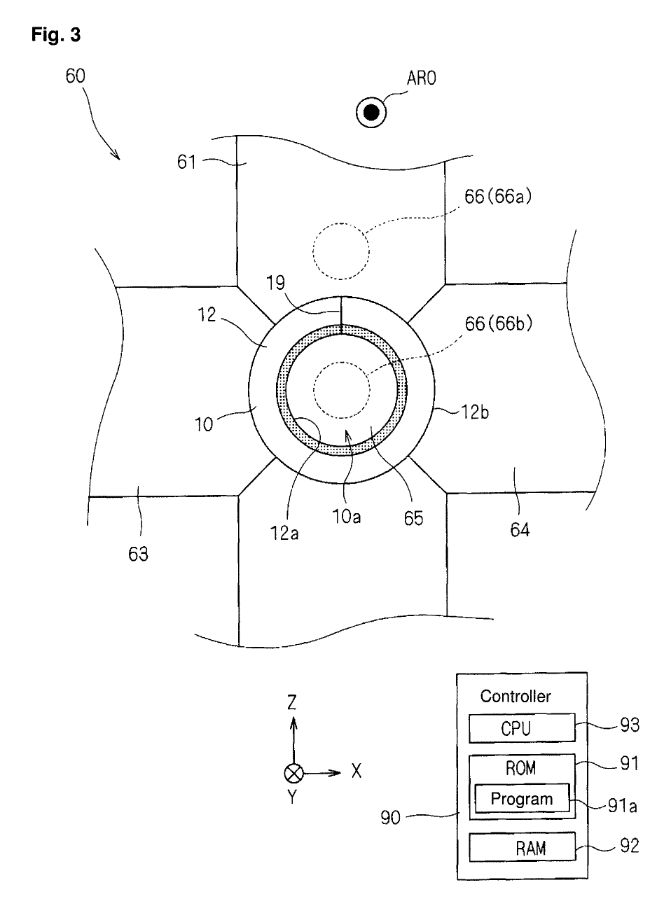

FIG. 2 is a side view illustrating an exemplary configuration of a mold 60 used for molding the protection structure 2. FIG. 3 is a side view illustrating an exemplary method of producing the protection structure 2. In the following, a configuration of the mold 60 is described first, and then the method of producing the protection structure 2 is described.

<2.1. Configuration of Mold>

The hardware configuration of the mold 60 is described below. The mold 60 heats and pressurizes the nonwoven fabric 12 so as to mold the nonwoven fabric 12 into the protector 10 having a tubular shape. With reference to FIG. 2, the mold 60 mainly includes an upper compressor 61, a lower compressor 62, side compressors 63 and 64, an inner surface former 65, and heaters 66 (66a and 66b).

The upper compressor 61 is a pressurizing component that applies pressure from above to the nonwoven fabric 12 provided around the inner surface former 65. As shown in FIG. 2, a contact surface 61 a is a curved surface extending in the direction of the arrow AR0 and having a circular arc shape in a side view.

The upper compressor 61 moves relative to the inner surface former 65 (descends in a direction of an arrow AR1, for example). The nonwoven fabric 12 is sandwiched by the upper compressor 61 and the inner surface former 65, and thus pressure is applied to a vicinity of an upper portion of the nonwoven fabric 12.

The lower compressor 62 is a pressurizing component that applies pressure from below to the nonwoven fabric 12 provided around the inner surface former 65. As shown in FIG. 2, the lower compressor 62 is provided on a side opposite the upper compressor 61 across the inner surface former 65. A contact surface 62a is a curved surface having a circular arc shape in a side view and having a shape similar to the contact surface 61a.

The lower compressor 62 moves relative to the inner surface former 65 (ascends in a direction of an arrow AR2, for example). The nonwoven fabric 12 is sandwiched by the lower compressor 62 and the inner surface former 65, and thus pressure is applied to a vicinity of a lower portion of the nonwoven fabric 12.

The side compressors 63 and 64 are pressurizing components that apply pressure from sides (a left side (plus side of an X-axis) and a right side (minus side of the X-axis) on a drawing sheet, respectively) to the nonwoven fabric 12 provided around the inner surface former 65. As shown in FIG. 2, the side compressor 64 is provided on a side opposite the side compressor 63 across the inner surface former 65. A contact surface 63a of the side compressor 63 and a contact surface 64a of the side compressor 64 are each a curved surface having a circular arc shape in a side view and having a shape similar to the contact surfaces 61a and 62a.

The side compressor 63 moves relative to the inner surface former 65 (moves in a direction of an arrow AR3, for example). The nonwoven fabric 12 is sandwiched by the side compressor 63 and the inner surface former 65, and thus pressure is applied to a left side (on the drawing sheet) of the nonwoven fabric 12. Meanwhile, the side compressor 64 moves relative to the inner surface former 65 (moves in a direction of an arrow AR4, for example). The nonwoven fabric 12 is sandwiched by the side compressor 64 and the inner surface former 65, and thus pressure is applied to a right side (on the drawing sheet) of the nonwoven fabric 12.

The inner surface former 65 is used for forming the inner space 10a in the protector 10. As shown in FIG. 2, the inner surface former 65 is a bar-shaped body extending in the arrow AR0 direction and having a circular shape in a side view. In forming the protector 10, the inner surface former 65 is placed so as to face a first surface 12a of the nonwoven fabric 12. The compressors 61 to 64 apply pressure to the nonwoven fabric 12 from upper, lower, left, and right sides of the inner surface former 65, respectively, to form the nonwoven fabric 12 into the tubular protector 10.

The heaters 66 (66a and 66b) are heating components that heat the nonwoven fabric 12. As shown in FIG. 2, the heaters 66a and 66b are each embedded in the upper compressor 61 and the inner surface former 65, respectively.

Accordingly, with the heater 66a driven, the upper compressor 61 increases in temperature and mainly heats the vicinity of the upper portion of the nonwoven fabric 12. On the other hand, with the heater 66b driven, the inner surface former 65 increases in temperature and mainly heats the first surface 12a of the nonwoven fabric 12.

A controller 90 performs, for example, control of heating by the heaters 66 (66a and 66b), data calculation, and the like. As shown in FIG. 2, the controller 90 mainly includes a ROM 91, a RAM 92, and a CPU 93. The controller 90 is electrically connected to the components of the mold 60 (e.g., the heaters 66 (66a and 66b)) through signal lines (not shown in the drawings), as shown in FIG. 2.

The ROM (Read Only Memory) 91 is a so-called nonvolatile memory and stores a program 91a, for example. The ROM 91 may be a flash memory, which is a readable and writable nonvolatile memory.

The RAM (Random Access Memory) 92 is a volatile memory and stores data used in calculation by the CPU 93, for example. The CPU (Central Processing Unit) 93 executes control based on the program 91a of the ROM 91 (e.g., control of heating to the nonwoven fabric 12), data calculation, and the like.

<2.2. Method of Producing Protection Structure Using Mold>

A method of producing the protection structure 2 using the mold 60 is described below with reference to FIGS. 2 and 3.

As shown in FIG. 2, the nonwoven fabric 12 is first placed so as to surround the inner surface former 65. Accordingly, the nonwoven fabric 12 is formed into a tubular body (see FIG. 2) that is neither compressed nor joined in a joint portion 19 (see FIG. 3).

Subsequently, the compressors 61 to 64 each relatively move toward the inner surface former 65. Accordingly, the nonwoven fabric 12 is compressed in a radial direction of the tubular body by the contact surfaces 61a to 64a of the compressors 61 to 64, respectively.

By this pressurizing process, the first surface 12a of the nonwoven fabric 12 is formed along an outer periphery of the inner surface former 65, and a second surface 12b of the nonwoven fabric 12 is formed along the contact surfaces 61a to 64a of the compressors 61 to 64, respectively. Accordingly, the first surface 12a of the nonwoven fabric 12 is formed into an inner peripheral surface of the protector 10, and the second surface 12b of the nonwoven fabric 12 is formed into an outer peripheral surface of the protector 10.

Furthermore, while the compressors 61 to 64 apply pressure, the heater 66a of the upper compressor 61 and the heater 66b of the inner surface former 65 are driven by the controller 90. Accordingly, the nonwoven fabrics 12 is heated at a temperature equal to or higher than the melting point of the binder material (second temperature) and lower than the melting point of the base material (first temperature).

Subsequently, heating by the heaters 66 (66a and 66b) is stopped, and then the protector 10 is cooled by air and the like. Thereby, a portion or all of the binder material of the first surface 12a and the joint portion 19 (see FIG. 3) is heated and melted, spread into the base material, and then cooled and solidified.

Accordingly, the joint portion 19 of the protector 10 is joined by the binder material that has been heated and melted and then cooled and solidified. Furthermore, because the binder material of the first surface 12a is heated and melted and then cooled and solidified, the first surface 12a (inner peripheral surface of the protector 10) facing the inner space 10a (see FIG. 1) is harder than the second surface 12b (outer peripheral surface of the protector 10).

Then, the plurality of electric wires 11 are inserted into the inner space 10a of the protector 10 formed in the pressurizing and heating processes, thus completing the production steps of the protection structure 2.

<3. Advantages of Protection Structure of Present Embodiment>

As described above, in the protection structure 2 of the present embodiment, the binder material in the first surface 12a is heated and melted and then cooled and solidified such that the first surface 12a (inner peripheral surface), which faces the inner space 10a, of the protector 10 is harder than the second surface 12b (outer peripheral surface) of the protector 10. Specifically, the binder material in the first surface 12a is spread into the base material and is then cooled and solidified, and thereby a waterproofing capability is conferred to the first surface 12a.

Thus, water adhered to the second surface 12b (outer peripheral surface) of the protector 10 is blocked by the first surface 12a of the protector 10. Therefore, the water is prevented from leaking into the inner space 10a of the protector 10 and from adhering to the plurality of electric wires 11.

<4. Modification>

The embodiment of the present invention was described above. The present invention, however, is not limited to the embodiment above and may be modified in various ways.

(1) In the present embodiment, the bundle of electric wires is the plurality of electric wires 11. However, it is not limited to the configuration above. For example, a bundle of electric wires may be composed of one electric wire 11, and the one electric wire 11 may be inserted into the inner space 10a of the protector 10.

(2) Furthermore, in the present embodiment, the nonwoven fabric 12 is heated by the heaters 66 (66a and 66b). However, it is not limited to the configuration above. For example, the nonwoven fabric 12 may be heated by the heater 66b only, as long as the joint portion 19 and the first surface 12a can be successfully heated by the heater 66b.

(3) Moreover, in the present embodiment, the protector 10 has a tubular shape. However, it is not limited to this shape. The protector 10 may be formed into a shape corresponding to a location (a shape fitting unevenness of the location, for example) where the protector 10 is provided. This enables easy wiring of the wire harness 1 in the location. Thus, a problem of unnecessary extension of the wire harness 1 is prevented.

### REFERENCE SIGNS LIST

1: Wire harness

2: Protection structure

7: Water

10: Protector

10a: Inner space

11: Electric wire

12: Nonwoven fabric

12a: First surface (inner peripheral surface)

12b: Second surface (outer peripheral surface)

19: Joint portion

60: Mold

61: Upper compressor

61a, 62a, 63a, and 64a: Contact surface

62: Lower compressor

63: Side compressor

64: Side compressor

65: Inner surface former

66 (66a and 66b): Heater

90: Controller

1. A wire harness protection structure, comprising:
(a) a bundle of electric wires; and
(b) a protector formed into a tubular body extending in a longitudinal direction of the bundle of electric wires and provided with a portion of the bundle of electric wires in an inner space of the tubular body, wherein
the protector is formed of a protection material that comprises a base material and a binder material having a melting point lower than that of the base material;
a joint portion of the protector is joined by heating and melting and then cooling and solidifying the binder material; and
the binder material in an inner peripheral surface, which faces the inner space, is heated and melted and then cooled and solidified such that the inner peripheral surface is harder than an outer peripheral surface of the protector.

2. The wire harness protection structure according to claim 1, wherein the protector is formed into a shape corresponding to a location where the protector is provided.
